(19) United States
(12) Patent Application Publication
(10) Pub. No.: US 2023/0401441 A1
(43) Pub. Date: Dec. 14, 2023

(54) DOMAIN TRANSFER OF TRAINING DATA FOR NEURAL NETWORKS

(71) Applicant: Robert Bosch GmbH, Stuttgart (DE)

(72) Inventor: Jens Eric Markus Mehnert, Malmsheim (DE)

(21) Appl. No.: 18/313,254

(22) Filed: May 5, 2023

(30) Foreign Application Priority Data
Jun. 8, 2022 (DE) 10 2022 205 841.0

(51) Int. Cl. G06N 3/08; G06N 3/045

(52) U.S. Cl. CPC G06N 3/08; G06N 3/045

(57) ABSTRACT

A method for training a generator network. In the method: training data records of the first domain and training data records of the second domain are provided; the training data records of the first domain are transformed into synthetic data records of the second domain using the generator network; the training data records and synthetic data records of the second domain are mapped by a task network to outputs relating to a predefined task; a saliency record is created comprising the saliencies with which portions of the training data record and of the synthetic data record respectively have contributed to the respective output of the task network; saliency records sampled from the pool of saliency records are classified by a discriminator network according to whether they belong to a training data record or a synthetic data record; the accuracy achieved in this classification is evaluated.

### CROSS REFERENCE

The present application claims the benefit under 35 U.S.C. § 119 of German Patent Application No. DE 10 2022 205 841.0 filed on Jun. 8, 2022, which is expressly incorporated herein by reference in its entirety.

### FIELD

The present invention relates to the translation of data records, which may contain, for example, measurement data of a sensor or of a sensor configuration,
to another domain, which may represent, for example, measurement data of another sensor or of another sensor configuration.

### BACKGROUND INFORMATION

Driving assistance systems and systems for at least partially automated driving require an automatedly analyzable representation of the vehicle's surroundings in order to control the vehicle such that it behaves in a manner best suited to the current traffic conditions. Representations of this type are ascertained using neural networks, which, for example, classify or alternatively semantically segment images, or alternatively radar or lidar data, from the vehicle's surroundings according to objects contained therein.

Such neural networks are often trained in a supervised manner. Training data labeled with target outputs that the neural network should output for the respective training data are used for this purpose. The greatest expense here comes from labeling with the target outputs, which generally requires manual work. Training with training data recorded using a specific sensor configuration enables the neural network to process, during live operation, measurement data recorded using the same sensor configuration. However, it offers no guarantee that the neural network will also supply usable results for measurement data recorded using a new or improved sensor configuration.

### SUMMARY

The present invention provides a method for training a generator network. According to an example embodiment of the present invention, the task of this generator network is to transform data records belonging to a first domain into synthetic data records belonging to a second domain. In the trained state, the generator network can then be utilized in particular, for example, to convert existing training data recorded using a first sensor or a first sensor configuration into synthetic data, such as a second sensor or a second sensor configuration would have been able to record in the same situation. These synthetic data can then be used, for example, to train a neural network to process measurement data of the second sensor or of the second sensor configuration. Insofar as the original training data are labeled with target outputs, these labels can continue to be utilized.

The term “domain”, generally speaking, denotes the fact that data records belonging to this domain have one or more common features. These common features may, for example, consist in that the data records
were acquired using the same measurement modality (for instance camera, radar, lidar, thermal image), and/or
were acquired under the same specific conditions (for instance at the same time of day or time of year, or alternatively from the same perspective), and/or
belong to a common distribution.

A domain does not have to be formulated in advance but may in particular, for example, also be defined by a set of data records belonging to it.

The term “record” is to be understood in the sense of a “data structure filled with data”, similarly to the term “record” as used in connection with a database, or to an index card in a card index box. A data record may contain, for example, an image, or a time series of measured values. Although, in principle, the term “dataset” would also be applicable, it is avoided here because, in the specialized language of machine learning, it is mainly associated with an entire set of data records. Using the analogy of index cards, such an entire set corresponds to the complete card index box comprising all the index cards therein.

Images as data records may in particular comprise, for example, pixels to which values of at least one variable, such as intensity values, are assigned. A classifier can then be configured in particular, for example, to assign images to one or more classes as a function of the values of at least some, or of all, of these pixels. Similarly, a classifier may be configured, for example, to assign time series to one or more classes as a function of at least some, or of all, of the measurement values contained therein.

According to an example embodiment of the present invention, in the context of the method, training data records of the first domain and training data records of the second domain are provided. The training data records of the first domain are transformed into synthetic data records of the second domain using the generator network. As explained above, in particular, for example,
training data records of the first domain may contain measurement data recorded using at least one first sensor and/or first sensor configuration, and/or
training data records of the second domain may contain measurement data recorded using at least one second sensor and/or second sensor configuration.

Both the training data records of the second domain and the synthetic data records of the second domain are mapped by a task network to outputs relating to a predefined task. Such a task network may be configured in particular, for example, to assign one or more classification scores, and/or a semantic segmentation, to the training data record, and to the synthetic data record respectively, of the second domain in relation to a predefined quantity of classes.

A saliency record is then created for each training data record and for each synthetic data record respectively, comprising the saliencies with which portions of the training data record and of the synthetic data record respectively have contributed to the respective output of the task network. These saliencies may contain in particular, for example, intensities and/or weights with which portions of the training data record and of the synthetic data record respectively have contributed to the respective output of the task network. In other words, the saliency can indicate to what extent the output of the task network is based on specific portions of the training data record and of the synthetic data record respectively and would possibly also be different if these portions were changed.

Thus, for example, in a task network which provides classification scores or a semantic segmentation, the saliencies may indicate to what extent portions of the training data record and of the synthetic data record respectively have contributed to the assignment of one or more specific classes to the training data record and to the synthetic data record respectively. A large number of methods exist for measuring such saliencies, which examine, for example, to what extent an error in portions of the data record impacts on the classification scores, or on the semantic segmentation.

For example, a saliency record for an image consisting of pixels may be a saliency image in which a saliency value is assigned to each pixel of the image and presented as an intensity value.

By considering saliencies, it is in particular also possible, for example, to distinguish actually learned knowledge of the task network from knowledge that has been “memorized” due to overfitting. In simplified terms, a saliency may be understood as a partial derivative of the output of the task network with respect to its input. An output of the task network based on overfitting is no longer capable of improvement, and is in this respect extremal, so that the derivative with respect to the input, i.e., the saliency, equals zero.

The saliency records are brought together in a pool. Saliency records are sampled, i.e., drawn randomly, from this pool. The sampled saliency records are classified by a discriminator network according to whether they
belong to a training data record that was part of the second domain from the start, or alternatively
belong to a synthetic data record that was originally part of the first domain and was only transferred to the second domain by the generator network.

The accuracy achieved in this classification is evaluated using a predefined transfer cost function. This accuracy may indicate, for example, the success rate with which the discriminator distinguishes training data records as “real” members of the second domain from synthetic data records as “fake” members of the second domain.

The generator network is then trained adversarially with the discriminator network. In other words, parameters that characterize the discriminator network are optimized with the aim of improving the evaluation by the transfer cost function (i.e., the “bounties” received for detected “fakes”). Conversely, parameters that characterize the behavior of the generator network are optimized with the aim of worsening the evaluation by the transfer cost function. In other words, the generator network refines its “fakes” such that they are harder for the discriminator network to detect.

This procedure is similar to the training of conventional generative adversarial networks. However, a significant difference is that the comparison between the training data records and the synthetic data records is decoupled from these data records themselves. Instead, effects of the respective data records on the results yielded by the task network are compared with each other by way of the saliencies.

As a result, the synthetic data records can be specifically tailored to have a similar effect to “real” training data records of the second domain when input into the task network. This does not necessarily correlate with the synthetic data records as such being difficult to distinguish from the “real” training data records of the second domain. The similarity of the synthetic data records to the “real” training data records is, in fact, a property only of the respective data records and is independent of the predefined task. In contrast, the effect of any differences on the output of the task network is dependent on the specific task.

Furthermore, the overall task of training is reduced significantly in its dimensionality and is thus simplified. For example, a very wide range of images as data records is condensed to identical or similar saliencies. When processing traffic conditions, for example, differences with regard to the color or texturing of the surfaces of involved vehicles can then be smoothed out. In particular, even in circumstances or situations that are represented relatively frequently in the overall set of training data records, the variability of the saliency is lower than the variability of the training data records themselves.

By considering saliencies, differences between tasks with similar content can also be smoothed out. Thus, the saliencies for pixels of an image are, for example, substantially independent of whether a recognition of bounding boxes around objects or a semantic segmentation of the image is required as the task. One and the same pixel is substantially equally relevant to both tasks.

Advantageously, according to an example embodiment of the present invention, the saliency records may additionally be labeled with the task network output to which they relate. In this way, the discriminator network obtains additional reference points for differentiating between synthetic data records on the one hand and training data records on the other hand. In particular, this differentiation may focus even more strongly on the effect that differences between the respective data records have on the task network output.

In one particularly advantageous embodiment, training data records which are in each case labeled with target outputs are selected. Deviations of the output of the task network from the target output relating to the respective training data record are evaluated using a task cost function. Parameters that characterize the behavior of the task network are optimized with the aim of improving the evaluation by the task cost function. In this way, it can be ensured that there is no loss of focus on achieving the task, despite all efforts to better “fakes” of training data records of the second domain with regard to the saliencies.

Furthermore, as a result of this training of the task network, the ability to process the synthetic data records is also improved. In principle, it is also possible to utilize a task network which has been trained using training data records of the second domain, and of which the parameters are retained. However, the already existing training of the task network mainly covers that part of the second domain in which the training data records used are found. Synthetic data records that have originated from completely different training data records in the first domain can be processed by the task network based on its power of generalization. However, the processing of these synthetic data records is not as “firm” as the processing of data records corresponding to the scope of the training already completed.

In a further particularly advantageous embodiment of the present invention, parameters that characterize the behavior of the task network are optimized with the aim of worsening the evaluation by the transfer cost function. In this way, the task network can assist the generator network in concealing differences between the synthetic data records and the training data records of the second domain from the discriminator network. In particular, for example, the task network can learn to become more invariant to such differences.

In a further particularly advantageous embodiment of the present invention, the saliencies in each saliency record relating to a training data record and to a synthetic data record respectively are aggregated. Using all the training data records and using all the synthetic data records respectively, a frequency distribution of the results obtained in the aggregation is then ascertained. This frequency distribution can be used as a “fingerprint” of the entire set of training data records and of the entire set of synthetic data records respectively with regard to their effect on the output of the task network.

For example, the transfer cost function can measure to what extent the frequency distribution ascertained using all the training examples on the one hand and the frequency distribution ascertained using all the synthetic data records on the other hand:
contain results of a similar order of magnitude, and/or
have similar shapes.

With the aid of contributions of this type, for example the parameters of the transfer cost function can be initialized at the start of the optimization. The optimization can therefore start from parameters for which the frequency distributions already contain results of a similar order of magnitude, and/or have similar shapes. The optimization is likely to converge better in this case than after a random initialization of the parameters.

As explained above, advantageously, a task network is selected which assigns one or more classification scores, and/or a semantic segmentation, to the training data record, and to the synthetic data record respectively, of the second domain in relation to a predefined quantity of classes.

As explained at the beginning, an important practical application of the generator network is to avoid the renewed physical acquisition, and in particular the renewed labeling, of training data records in this second domain by transferring training data records from the first domain to the second domain.

In a further particularly advantageous embodiment of the present invention, therefore, further training data records of the first domain, each labeled with target outputs, are converted into synthetic data records of the second domain using the trained generator network. The task network undergoes supervised training or further training with these synthetic data records as further training data records of the second domain and with continued use of the target outputs relating to the further training data records of the first domain from which the synthetic data records were ascertained.

For example, a stock of training images may already have been recorded using a first camera system and then labeled. If the first camera system is then to be exchanged for a second one with a better lens and better chip technology, the existing training images may be converted, using the generator network, into new training images of the domain defined by the images supplied by the second camera system. The task network may then undergo supervised training on this domain without the need for new images to be recorded or even labeled.

In a further particularly advantageous embodiment of the present invention, the task network that has been trained in this way can then be supplied with data records of the second domain comprising measurement data recorded using at least one sensor. A control signal may be formed from the output subsequently supplied by the task network. A vehicle, a system for quality control, a system for area monitoring, and/or a system for medical imaging may then be controlled using this control signal. In this way, there is a greater probability that the reaction of the system being controlled in each case is appropriate to the situation captured by the at least one sensor.

According to example embodiment of the present invention, the method may be entirely or partially computer-implemented, and thus embodied in software. The present invention therefore also relates to a computer program comprising machine-readable instructions which, when they are executed on one or more computers and/or compute instances, cause the computer(s) and/or compute instance(s) to execute the method described here. In this sense, control devices for vehicles, and embedded systems for technical equipment, that are likewise capable of executing machine-readable instructions are also to be regarded as computers. Compute instances may be in particular, for example, virtual machines, containers, or other execution environments for executing program code in a cloud.

The present invention likewise relates to a machine-readable data carrier and/or to a download product comprising the computer program. A download product is a digital product capable of being transmitted via a data network, i.e., capable of being downloaded by a user of the data network, which may, for example, be offered for sale in an online store for immediate download.

Furthermore, one or more computers and/or compute instances may be equipped with the computer program, with the machine-readable data carrier, and/or with the download product.

Further measures improving the present invention will be presented in more detail below with the aid of figures together with the description of the preferred exemplary embodiments of the present invention.

### BRIEF DESCRIPTION OF THE DRAWINGS

FIG. 1 shows an exemplary embodiment of the method 100 for training a generator 1, according to the present invention.

FIG. 2 illustration of the significance of saliencies for the domain transfer, according to an example embodiment of the present invention.

### DETAILED DESCRIPTION OF EXAMPLE EMBODIMENTS

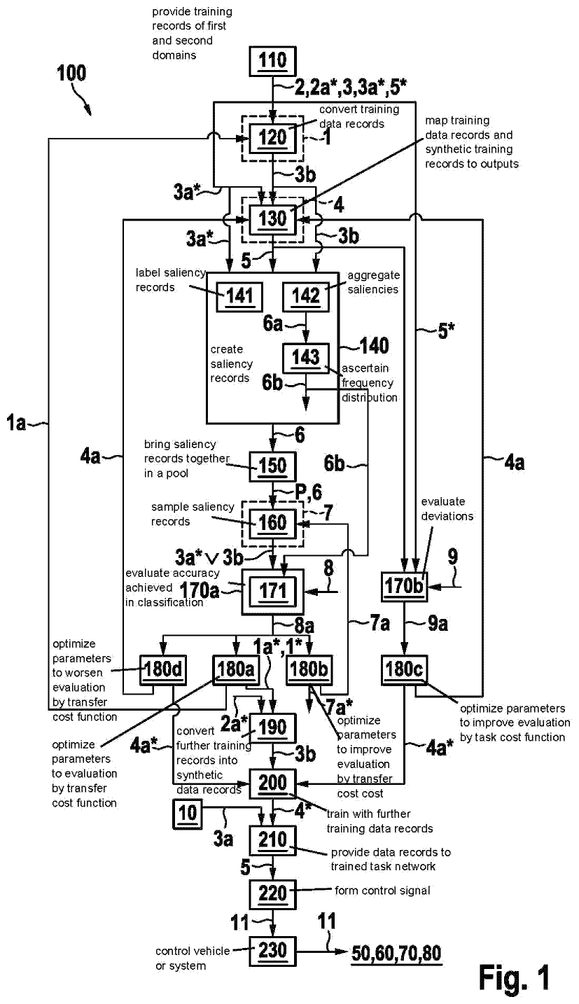

FIG. 1 is a schematic flow chart of an exemplary embodiment of method 100 for training a generator network 1. Generator network 1 has the task of transforming data records 2a which belong to a first domain 2 into synthetic data records 3b which belong to a second domain 3.

In step 110, training data records 2a* of first domain 2 and training data records 3a* of second domain 3 are provided. Training data records 2a*, 3a* may be labeled with target outputs 5*.

In step 120, training data records 2a* of first domain 2 are transformed into synthetic data records 3b of second domain 3 using generator network 1.

In step 130, both training data records 3a* of second domain 3 and synthetic data records 3b of second domain 3 are mapped by a task network 4 to outputs 5 relating to a predefined task.

In step 140, a saliency record 6 is created for each training data record 3a* and for each synthetic data record 3b respectively, comprising the saliencies with which portions of training data record 3a* and of synthetic data record 3b respectively have contributed to the respective output 5 of task network 4.

According to block 141, saliency records 6 may additionally be labeled with the output 5 of task network 4 to which they relate.

According to block 142, the saliencies in each saliency record 6 that relates to a training data record 3a*, and to a synthetic data record 3b respectively, may be aggregated into a result 6a.

According to block 143, a frequency distribution 6b of the results 6a obtained in the aggregation may then be ascertained using all training data records 3a* and using all synthetic data records 3b respectively.

In step 150, saliency records 6 are brought together in a pool P.

In step 160, saliency records 6 sampled from pool P are classified by a discriminator network 7 according to whether they belong to a training data record 3a* or to a synthetic data record 3b.

In step 170a, the accuracy achieved in this classification is evaluated using a predefined transfer cost function 8.

According to block 171, transfer cost function 8 may in particular, for example, measure to what extent the frequency distribution 6b ascertained using all training data records 3a* on the one hand, and the frequency distribution 6b ascertained using all synthetic data records 3b on the other hand:
contain results of a similar order of magnitude, and/or
have similar shapes.

In step 180a, parameters 1a that characterize the behavior of generator network 1 are optimized with the aim of worsening evaluation 8a by transfer cost function 8. At the same time, in step 180b, parameters 7a that characterize the behavior of discriminator network 7 are optimized with the aim of improving evaluation 8a by transfer cost function 8. Generator network 1 and discriminator network 7 are therefore adversarially trained against each other. The finished, optimized state of parameters 1a is referred to by the reference numeral 1a*. These parameters 1a* define the finished, optimized state 1* of generator network 1.

In step 170b, deviations of output 5 of task network 4 from target output 5* relating to the respective training data record 2a*, 3a* are evaluated using a task cost function 9. Target output 5* relating to a training data record 2a* of first domain 2 is also regarded here as a target output 5* relating to a synthetic data record 3b of second domain 3 generated therefrom.

In step 180c, parameters 4a that characterize the behavior of task network 4 are optimized with the aim of improving evaluation 9a by task cost function 9.

In step 180d, parameters 4a that characterize the behavior of task network 4 are additionally optimized with the aim of worsening evaluation 8a by transfer cost function 8.

In step 190, further training data records 2a* of first domain 2, which are each labeled with target outputs 5*, are converted into synthetic data records 3b of second domain 3 using trained generator network 1*.

In step 200, task network 4 undergoes supervised training or further training with these synthetic data records 3b as further training data records of second domain 3, with continued use of target outputs 5* relating to further training data records 2a* of first domain 2 from which synthetic data records 3b were ascertained. This training starts from parameters 4a* of task network 4 which were already optimized in steps 180c and 180d. The completely trained state of task network 4 is referred to by reference numeral 4*.

In step 210, data records 3a of second domain 3 comprising measurement data recorded using at least one sensor 10 are provided to the trained or further trained task network 4*.

In step 220, a control signal 11 is formed from the output 5 subsequently supplied by task network 4*.

In step 230, a vehicle 50, a system 60 for quality control, a system 70 for area monitoring, and/or a system 80 for medical imaging is controlled using control signal 11.

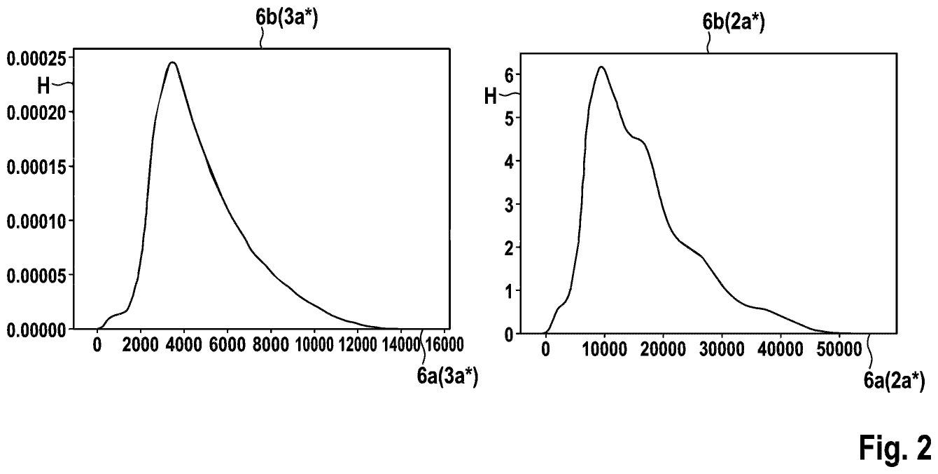

FIG. 2 illustrates why the saliencies form suitable feedback for the domain transfer in the context of the training method proposed here.

In the example shown in FIG. 2, training images of traffic conditions were recorded using two different camera configurations. Training images 2a* recorded using the first camera configuration form first domain 2. Training images 3a* recorded using the second camera configuration form second domain 3.

Each image 2a*, 3a* was provided to a task network 4 trained on the respective domain 2, 3, and a saliency was ascertained for each pixel of image 2a*, 3a* with respect to the respective output 5 of task network 4. These saliencies were aggregated into a mean value as result 6a(2*), 6a(3*) for the respective image 2a*, 3a*.

In FIG. 2, distributions 6b(2a*), 6b(3a*) of the frequencies H of aggregation results 6a(2a*), 6a(3a*) are plotted. It is striking here that aggregation results 6a(2a*), 6a(3a*) plotted on the horizontal axis extend over significantly different value ranges and the shapes of the distributions also differ markedly from each other. Examples of reasons contributing to this are:
different light transmissions of different materials in the two camera configurations;
different designs of the two camera configurations, and
different sensitivities of the respective camera chips.

Overall, it may be assumed that the two camera configurations produce markedly different information contents per pixel, both qualitatively and quantitatively.

What is claimed is:

1. A method for training a generator network for a task of transforming data records belonging to a first domain into synthetic data records belonging to a second domain, comprising the following steps:
providing training data records of the first domain and training data records of the second domain;
transforming the training data records of the first domain into synthetic data records of the second domain using the generator network;
mapping, by a task network, both the training data records of the second domain and the synthetic data records of the second domain, to respective outputs relating to a predefined task;
creating a respective saliency record for each of the training data records and for each of the synthetic data record, including saliencies with which portions of the training data record and of the synthetic data record respectively have contributed to the respective output of the task network;
bringing the respective saliency records together in a pool;
classifying, by a discriminator network, saliency records sampled from the pool according to whether they belong to a training data record or to a synthetic data record;
evaluating, using a predefined transfer cost function, an accuracy achieved in the classification using a predefined transfer cost function;
optimizing parameters that characterize behavior of the generator network with a goal of worsening the evaluation by the transfer cost function; and
optimizing parameters that characterize behavior of the discriminator network with a goal of improving the evaluation by the transfer cost function.

2. The method as recited in claim 1, wherein:
the training data records of the first domain contain measurement data recorded using at least one first sensor and/or first sensor configuration; and/or
the training data records of the second domain contain measurement data recorded using at least one second sensor and/or second sensor configuration.

3. The method as recited in claim 1, wherein the saliency records are additionally labeled with the output of the task network to which they relate.

4. The method as recited in claim 1, wherein:
training data records which are labeled with target outputs are selected;
deviations of the output of the task network from the target output relating to the respective training data record are evaluated using a task cost function; and
parameters that characterize behavior of the task network are optimized with a goal of improving the evaluation by the task cost function.

5. The method as recited in claim 1, wherein parameters that characterize behavior of the task network are optimized with a goal of worsening the evaluation by the transfer cost function.

6. The method as recited in claim 1, wherein:
the saliencies in each saliency record that relates to a training data record and to a synthetic data record respectively are aggregated, and
using all the training data records and using all the synthetic data records respectively, a frequency distribution of results obtained in the aggregation is ascertained.

7. The method as recited in claim 6, wherein the transfer cost function measures to what extent the frequency distribution ascertained using all the training data records on the one hand and the frequency distribution ascertained using all the synthetic data records on the other hand:
contain results of a similar order of magnitude, and/or
have similar shapes.

8. The method as recited in claim 1, wherein the saliencies contain intensities and/or weights with which portions of the training data record and of the synthetic data record respectively have contributed to the respective output of the task network.

9. The method as recited in claim 1, wherein the task network is configured to assign one or more classification scores and/or a semantic segmentation to the training data record, and to the synthetic data record respectively, of the second domain in relation to a predefined quantity of classes.

10. The method as recited in claim 9, wherein the saliencies indicate to what extent portions of the training data record and of the synthetic data record respectively have contributed to the assignment of one or more specific classes to the training data record and to the synthetic data record respectively.

11. The method as recited in claim 1, wherein:
further training data records of the first domain, each labeled with target outputs, are converted into synthetic data records of the second domain using the trained generator network; and
the task network undergoes supervised training or further training with the synthetic data records to which the further training data records are converted, as further training data records of the second domain, with continued use of the target outputs relating to the further training data records of the first domain from which the synthetic data records were ascertained.

12. The method as recited in claim 11, wherein:
the trained or further trained task network is supplied with data records of the second domain including measurement data recorded using at least one sensor;
a control signal is formed from the output subsequently supplied by the task network; and
a vehicle and/or a system for quality control and/or a system for area monitoring and/or a system for medical imaging, is controlled using the control signal.

13. A non-transitory machine-readable data carrier on which is stored a computer program for training a generator network for a task of transforming data records belonging to a first domain into synthetic data records belonging to a second domain, the computer program, when executed by one or more computers and/or compute instances, cause the one or more computers and/or compute instances to perform the following steps:
providing training data records of the first domain and training data records of the second domain;
transforming the training data records of the first domain into synthetic data records of the second domain using the generator network;
mapping, by a task network, both the training data records of the second domain and the synthetic data records of the second domain, to respective outputs relating to a predefined task;
creating a respective saliency record for each of the training data records and for each of the synthetic data record, including saliencies with which portions of the training data record and of the synthetic data record respectively have contributed to the respective output of the task network;
bringing the respective saliency records together in a pool;
classifying, by a discriminator network, saliency records sampled from the pool according to whether they belong to a training data record or to a synthetic data record;
evaluating, using a predefined transfer cost function, an accuracy achieved in the classification using a predefined transfer cost function;
optimizing parameters that characterize behavior of the generator network with a goal of worsening the evaluation by the transfer cost function; and
optimizing parameters that characterize behavior of the discriminator network with a goal of improving the evaluation by the transfer cost function.

14. One or more computers and/or compute instances configured to train a generator network for a task of transforming data records belonging to a first domain into synthetic data records belonging to a second domain, the one or more computers and/or compute instances configured to:
provide training data records of the first domain and training data records of the second domain;
transform the training data records of the first domain into synthetic data records of the second domain using the generator network;
map, by a task network, both the training data records of the second domain and the synthetic data records of the second domain, to respective outputs relating to a predefined task;
create a respective saliency record for each of the training data records and for each of the synthetic data record, including saliencies with which portions of the training data record and of the synthetic data record respectively have contributed to the respective output of the task network;
bring the respective saliency records together in a pool;
classify, using a discriminator network, saliency records sampled from the pool according to whether they belong to a training data record or to a synthetic data record;
evaluate, using a predefined transfer cost function, an accuracy achieved in the classification using a predefined transfer cost function;
optimize parameters that characterize behavior of the generator network with a goal of worsening the evaluation by the transfer cost function; and
optimize parameters that characterize behavior of the discriminator network with a goal of improving the evaluation by the transfer cost function.
